(19) United States
(12) Patent Application Publication
(10) Pub. No.: US 2008/0104656 A1
(43) Pub. Date: May 1, 2008

(54) Method of storing and reproducing interactive digital broadcast signals and apparatus therefor

(75) Inventor: Deok-ho Kim, Seocho-gu (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/727,085

(22) Filed: Mar. 23, 2007

(30) Foreign Application Priority Data
Oct. 26, 2006 (KR) 10-2006-0104687

(51) Int. Cl. H04N 7/173

(52) U.S. Cl. 725/134

(57) ABSTRACT

A method of concurrently storing an input history of a user as interactive service control information in addition to an AV stream and data content which are digital broadcast signals and an apparatus therefor are provided. Accordingly, the user can determine when and how the user acted during an interactive digital broadcast service while reproducing a recorded broadcast program by receiving digital broadcast signals including an AV stream and data content through an external interactive communication channel, receiving interactive service control information that is input by a user on the basis of the data content and storing the AV stream, the data content, and the interactive service control information.

### CROSS-REFERENCE TO RELATED PATENT APPLICATION

This application claims the benefit of Korean Patent Application No. 10-2006-0104687, filed on Oct. 26, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to storing interactive digital broadcast signals, and more particularly, to a method of concurrently storing an input history of a user as interactive service control information in addition to an AV stream and data content which are digital broadcast signals.

2. Description of the Related Art

A typical example of an apparatus for storing a broadcast stream is a personal video recorder (PVR) system. The PVR system may also be referred to as a digital video recorder system. The PVR system includes a hard disk drive (HDD, hereinafter is referred to as a hard disk) which generally stores a stream (audio/video (AV) stream or data content) of a broadcast program that is transmitted from a broadcast station in real time through a wired or wireless network and reproduces the stream when a user desires.

Unlike a video cassette recorder (VCR) that stores image signals on a magnetic tape, the PVR is a digital recorder for recording and reproducing broadcast information in a hard disk or memory chip. A function of the PVR is similar to that of the VCR in that a program from a broadcast station is stored and reproduced. However, the function of the PVR is different from that of the VCR in that the program is recorded in the hard disk and reproduced by using the same method as a method of reproducing a file in a computer, and the PVR includes a memory chip, which includes a central processing unit (CPU) for reproduction, an operating system, and reproducing software, and a mass storage hard disk for storing broadcast content. Unlike an existing analogue VCR, the PVR system maintains image quality without information loss regardless of the number of times that recording and reproducing is performed and performs similar function as the VCR by storing the audio and video information as digital data.

In addition, the PVR system supports a time shift function for concurrently storing and reproducing a broadcast program while watching the broadcast program. For example, in this time shift function, in a case where a user gets a phone call while watching a broadcast program, when the user presses a pause button of a remote controller, the subsequently received broadcast stream is stored in the hard disk. When the user presses a play button again after the phone call, the user can watch the broadcasting program from the paused scene, which is stored in the hard disk. That is to say, the PVR system continuously and concurrently stores and reproduces the broadcast program for a predetermined time interval by using the time shift function.

FIG. 1 is a functional block diagram illustrating a related art PVR.

Referring to FIG. 1, the related art PVR schematically includes a tuner 110, a hard disk 120, a decoder 130, and a renderer 140.

The tuner 110 selectively receives a signal with a broadcast frequency, which is transmitted from a broadcast station. The received signal is stored in the hard disk 120. The broadcast signal stored in the hard disk is decoded by the decoder 130. The renderer 140 finally displays video data and audio data by transmitting the video data and the audio data to a buffer of a corresponding device driver.

However, the related art PVR system does not expect the interactive broadcast service to be supplied and accordingly, does not store the control information that is input by the user in the interactive digital broadcast service, that is, a user action. In the case of interactive digital broadcasting, the data content and the control information that is input by the user, in addition to the AV stream, are required to be stored. The user can determine which action the he or she performed while reproducing the broadcast program later. Specifically, when the user purchases a product, it is necessary that the user can obtain the information on when and how the user purchased the product.

### SUMMARY OF THE INVENTION

The present invention provides a method of concurrently storing input history of a user as interactive service control information in addition to an AV stream and data content, which are digital broadcast signals, when the interactive digital broadcast signals are stored, and an apparatus therefor.

The present invention also provides a method of concurrently reproducing interactive service control information as input history of a user in addition to an AV stream and data content, which are digital broadcast signals, when the interactive digital broadcast signals are reproduced, and an apparatus therefor.

According to an aspect of the present invention, there is provided a method of storing interactive digital broadcast signals, comprising: receiving digital broadcast signals including an AV stream and data content through an external interactive communication channel; receiving interactive service control information that is input by a user on the basis of the data content; and storing the AV stream, the data content, and the interactive service control information.

In the above aspect of the present invention, the storing of the AV stream, the data content, and the interactive service control information may comprise storing time information in order to synchronize the AV stream, the data content, and the interactive service control information with one another.

In addition, the interactive service control information may be stored in a metadata format, and the metadata may be in accordance with the extensible markup language (XML) standard.

In addition, the method of storing the interactive digital broadcast signals may further comprise separating the received AV stream and the data content as separate files after the receiving of the AV stream and the data content.

In addition, in the storing of the AV stream and the data content, the interactive service control information that is input by the user may be stored as the same file as the separate AV stream and the data content or as a file separated from the separate AV stream and the data content.

In addition, the stored interactive service control information may represent an input history of the user corresponding to the time information in a time order.

According to another aspect of the present invention, there is provided a method of reproducing interactive digital broadcast signals, comprising: selecting a content list of digital broadcast signals; searching for and reading digital broadcast signals of the selected content; parsing the read digital broadcast signal into an AV stream, data content, and interactive service control information which is representing input information of a user with respect to the data content; and reproducing the parsed AV stream, the data content, and the interactive service control information.

In the above aspect of the present invention, the method of reproducing the interactive digital broadcast signals may further comprise multiplexing the AV stream, the data content, and the interactive service control information by using time information in order to synchronize the AV stream, the data content, and the interactive service control information, after the parsing of the read digital broadcasting signal.

In addition, the interactive service control information may have a metadata format and represents the input history of the user corresponding to the time information, and the metadata may be in accordance with the extensible markup language (XML) standard.

In addition, the input history of the user with respect to the reproduced content may be represented by a text or graphical type.

According to another aspect of the present invention, there is provided a method of concurrently storing and reproducing interactive digital broadcast signals, comprising: receiving an AV stream and data content which are digital broadcast signals through an external interactive communication channel; receiving interactive service control information that is input by a user on the basis of the data content; storing the AV stream, the data content, and the interactive service control information; parsing the stored AV stream, the data content, and the interactive service control information; and reproducing the parsed AV stream, the data content, and the interactive service control information.

According to another aspect of the present invention, there is provided an apparatus for storing interactive digital broadcast signals, comprising: a tuner receiving an AV stream and data content which are digital broadcast signals through an external interactive communication channel; a classifier separating the received AV stream and the data content so as to be separate files; a user input unit receiving interactive service control information that is input by a user on the basis of the data content; and a storage unit storing the separated AV stream, the data content, and the interactive service control information

According to another aspect of the present invention, there is provided an apparatus for reproducing interactive digital broadcast signals, comprising: a storage unit storing AV stream, data content, and interactive service control information which are digital broadcast signals; a selector selecting a content list of stored digital broadcast signals; an extractor extracting the AV stream, the data content, and the interactive service control information by searching for the digital broadcast signals of the selected data content; a decoder decoding the extracted digital broadcast signals; a multiplexer multiplexing the AV stream, the data content, and the extracted interactive service control information which are the decoded digital broadcast signals by using time information in order to synchronize the AV stream, the data content, and the extracted interactive service control information with one another; and a display unit outputting the multiplexed AV stream, the data content, and the interactive service control information onto a screen.

According to another aspect of the present invention, there is provided a computer-readable recording medium having embodied thereon a computer program for executing the aforementioned methods and a television (TV) that includes the aforementioned apparatuses.

### BRIEF DESCRIPTION OF THE DRAWINGS

The above and other aspects of the present invention will become more apparent by describing in detail exemplary embodiments thereof with reference to the attached drawings in which:

FIG. 1 is a functional block diagram illustrating a related art;

FIG. 2 is a flowchart illustrating a method of storing interactive digital broadcast signals according to an exemplary embodiment of the present invention;

FIG. 3 illustrates XML code data which represents stored interactive service control information;

FIG. 4 is a flowchart illustrating a method of reproducing interactive digital broadcast signals according to another exemplary embodiment of the present invention;

FIG. 5 is a flowchart illustrating a method of concurrently storing and reproducing interactive digital broadcast signals according to another exemplary embodiment of the present invention;

FIG. 6 is a functional block diagram illustrating an apparatus for storing interactive digital broadcast signals according to an exemplary embodiment of the present invention; and

FIG. 7 is a functional block diagram illustrating an apparatus for reproducing interactive digital broadcast signals according to an exemplary embodiment of the present invention.

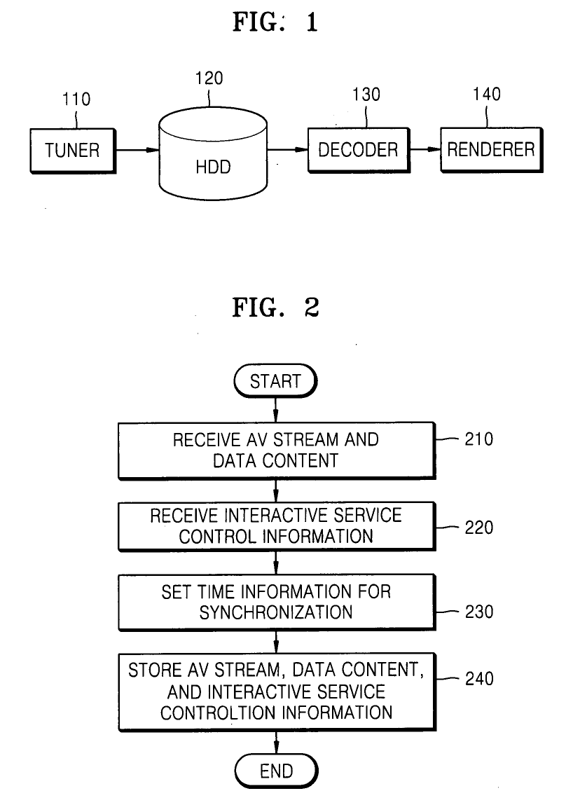

### DETAILED DESCRIPTION OF EXEMPLARY EMBODIMENTS OF THE INVENTION

Exemplary embodiments of the present invention will be described in detail with reference to the attached drawings.

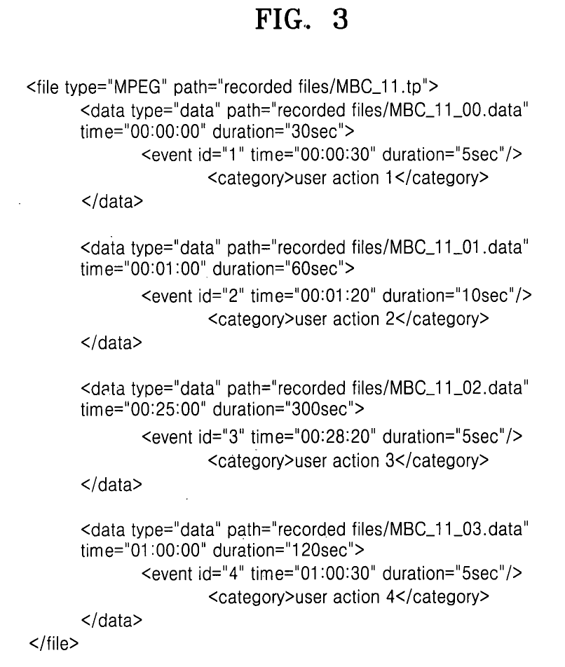

FIG. 2 is a flowchart illustrating a method of storing interactive digital broadcast signals according to an exemplary embodiment of the present invention.

The method of storing interactive digital broadcast signals will be described with reference to FIG. 2. First, digital broadcast signals are received through an external wired/wireless interactive communication channel (operation 210). The received broadcast signals include an AV stream and data content. In general, the AV stream is a data stream which is compressed and encoded on the basis of the Moving Picture Experts Group (MPEG) standard. The data content represents various additional data content including texts, images, sounds that are independent of a program broadcast service of the AV stream. The data content is classified into a program related service and a program independent service. The program related service provides additional information related to the program, for example, a plot of a drama, a synopsis of a movie, a score situation of a sport game, an introduction of panelists of a show program, and an introduction of properties, and furthermore application data of an audience response function such as a public opinion poll or popularity poll related to the program, and information on purchasing of stage properties. On the other hand, the program independent service, which is a separate broadcast program, provides information on weather, traffic, or stock, and application data such as reservation of lodging for sightseeing, reservation of transportation, and application for an event while watching a drama. In this case, the user's action may always intervene in the broadcast program, for example, when the user participates in the public opinion poll or popularity related poll, or purchases stage properties, the user can input practical data like the reservation of lodging, the reservation of transportation, and the application for an event. The history of the user input is received as the interactive service control information (operation 220). In order to synchronize the AV stream and the data content with the interactive service control information input by the user, time information is set by using the time when each event occurs (operation 230). The AV stream, the data content, and the interactive service control information are stored (operation 240).

It is important to store the interactive service control information in addition to the AV stream and the data content. This indicates that the input history of the user corresponding to the time information is represented as a history record in a time order. That is to say, the user can record and confirm when and how the user did the action while watching a particular broadcast program.

In operation 210, a process of separating the AV stream and the data content as separate files by receiving and analyzing the digital broadcast signals through the external wired/wireless interactive communication channel may be further performed. The aforementioned process is performed in order to optimize the storage space and make a search process as effective as possible. The separated AV stream and the data content may be stored together with the interactive service control information input by the user in the hard disk.

The interactive service control information input by the user may be stored as a file separated from the AV stream and the data content or as the same file as the AV stream and the data content.

Hereinafter, referring to FIG. 3, an example of codes of the interactive service control information is described.

FIG. 3 illustrates XML code data which represents stored interactive service control information

Referring to FIG. 3, the interactive service control information has a metadata format. Here, the metadata is used for describing an attribute of an information resource as data that relates to data. Specifically, the metadata is not the data which the user wants to store (for example, video, audio and/or text data) but the data for representing information which directly or indirectly relates to the data that is to be stored. Since a system can easily and rapidly find and extract the data desired by the user, the interactive service control information is represented in the metadata format. As shown in FIG. 3, the interactive service control information is represented by using XML that is a typical metadata language.

First, ‘file type’ represents a type of an AV broadcast stream. Here, the type of the AV broadcast stream is in accordance with the MPEG standard and stored as a file named “MBC_{—}11.tp”. In the data content, the file named “MBC_{—}11.tp” is created (00:00:00), and specific data is simultaneously stored in a file named “MBC_{—}11_{—}000.data” for 30 seconds. A user input (user action 1) is performed for 5 seconds after the 30 seconds (00:00:30). Hereinafter, the rest of codes may be understood in the same manner. Accordingly, an AV stream, data content, and interactive service control information are synchronized with one another and stored with reference to time information.

Since the same data is stored using the same file name, it is unnecessary to store massive data such as application data twice. For example, when data named “MBC_{—}11_{—}00.data” is application data for purchasing a dress of a principal character, it is unnecessary to store the same application data again in the next episode of the drama, and the previously stored data is available.

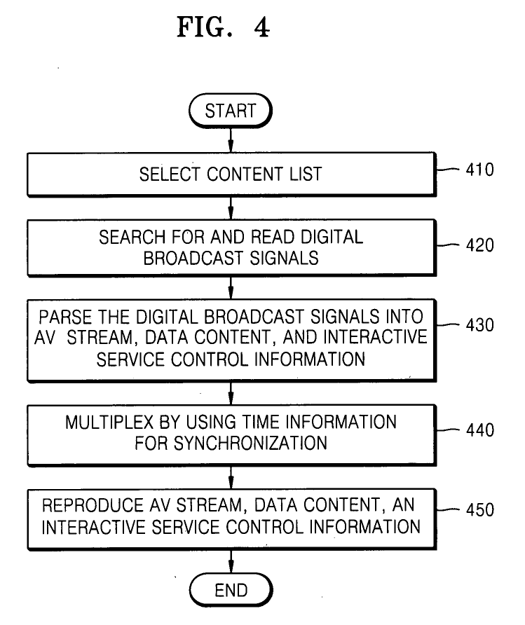

FIG. 4 is a flowchart illustrating a method of reproducing interactive digital broadcast signals according to another exemplary embodiment of the present invention.

Referring to FIG. 4, in the method of reproducing interactive digital broadcast signals, first, a content list of digital broadcast signals stored in the storage unit is selected (operation 410). Specifically, when there are stored a plurality of files, a file that a user desires to be reproduced is selected from among the files.

Next, the digital broadcast signals of the selected content are found and read (operation 420), and the read digital broadcast signals are parsed into the AV stream, the data content, and the interactive service control information (operation 430). It is determined whether the digital broadcast signal that is read by using the parsing process includes the data content and the interactive service control information. When the digital broadcast signal includes the data content and the interactive service control information, the digital broadcast signal is reproduced according to each sequence of the interactive service control information.

However, since the parsed AV stream, the data content, and the interactive service control information are finally reproduced together, the parsed AV stream, the data content, and the interactive service control information are multiplexed (operation 440). Synchronization of each sequence is matched by using the aforementioned time information. Specifically, as shown in FIG. 3, the AV stream and the data content file such as “MBC_{—}11.tp” or “MBC_{—}11_{—}00.data”, and the interactive service control information for representing the input history of usage which occurs at a specific time (for example, for 5 seconds from 00:00:30) are synchronized in correspondence with the correlated time information.

Finally, the AV stream, the data content, and the interactive service control information are reproduced on the screen. The interactive service control information for representing the input history of the user may be represented as text type information such as a subtitle including letters or as graphical motion when the user performs the input action.

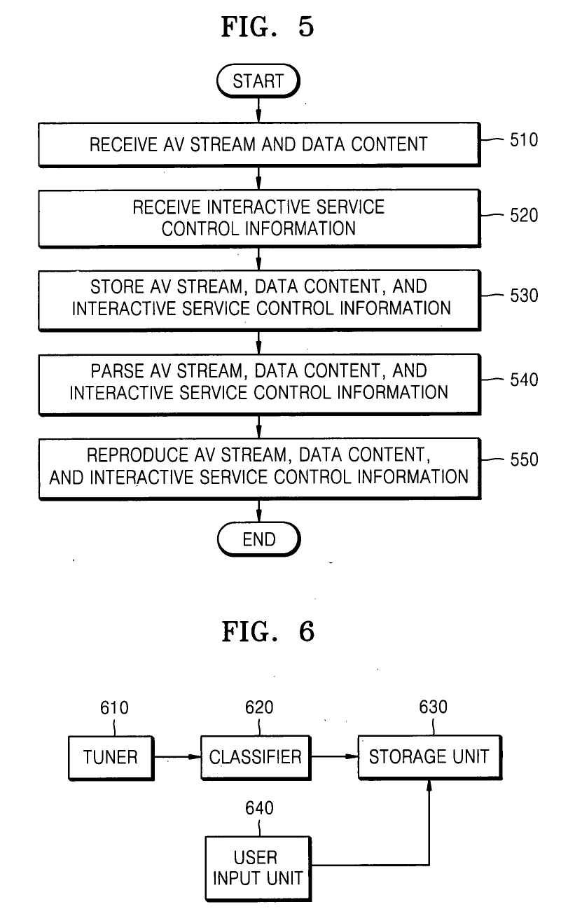

FIG. 5 is a flowchart illustrating a method of concurrently storing and reproducing interactive digital broadcast signals according to another exemplary embodiment of the present invention.

In the aforementioned method of storing and reproducing the interactive digital broadcast signals, the storing process and the reproducing process are separated. However, in the following exemplary embodiment, a storing process and a process of reproducing a stored file are concurrently performed.

Referring to FIG. 5, first, digital broadcast signals including an AV stream and data content are received through an external wired/wireless interactive communication channel (operation 510). At the same time, a user intervenes with the receiving of the digital broadcast signals. The input history of the user is received as a type of interactive service control information (operation 520). Then, the AV stream, the data content, and the interactive service control information are stored (operation 530).

The stored digital broadcast signals are parsed into the AV stream, the data content, and the interactive service control information (operation 540), and the parsed AV stream, the data content, and the interactive service control information are reproduced on a screen while storing the AV stream, the data content, and the interactive service control information.

Accordingly, a time shift reproduction in which the broadcast content received in real time can be stored and then reproduced from a desired point like the VCR when the user wants to reproduce the broadcast content by using the method of concurrently storing and reproducing the interactive digital broadcast signals. Since the interactive service control information for representing the input history of the user is stored, the user can reconfirm options selected by the user before several tens of seconds, for example, when the user purchases products.

FIG. 6 is a functional block diagram illustrating an apparatus for storing interactive digital broadcast signals according to an exemplary embodiment of the present invention.

Referring to FIG. 6, the apparatus for storing interactive digital broadcast signals includes a tuner 610, a classifier 620, a storage unit 630, and a user input unit 640.

The tuner 610 selectively receives signals having a broadcast frequency, which are transmitted from a broadcast station, like a tuner of the related art apparatus for storing broadcast signals.

The classifier 620 classifies the received broadcast signals into an AV stream and data content by analyzing the received broadcast signals and transmits the classification result to the storage unit 630.

The storage unit 630 stores the classified AV stream and the data content in a format of a digital data signal so that the AV stream and the data content can be repeatedly stored and reproduced without loss.

The user input unit 640 receives control information that is input by the user, which is the interactive service control information. The received interactive service control information is stored in the storage unit 630 together with the AV stream and the data content.

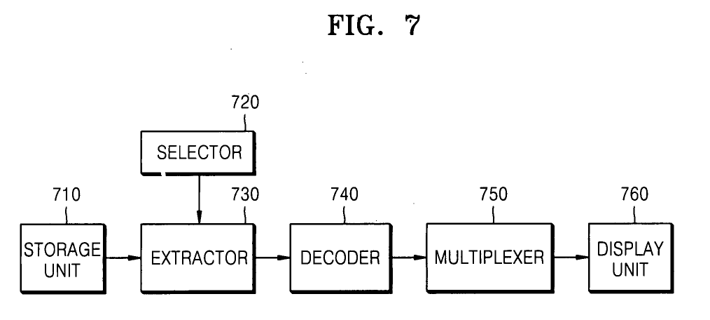

FIG. 7 is a functional block diagram illustrating an apparatus for reproducing interactive digital broadcast signals.

Referring to FIG. 7, the apparatus for reproducing interactive digital signals includes a storage unit 710, a selector 720, an extractor 730, a decoder 740, a multiplexer 750, and a display unit 760.

The selector selects specific data content through a process of selecting a data content list of the stored digital broadcast signals. The extractor 730 extracts the AV stream, the data content, and the interactive service control information by searching for the digital broadcast signal of the data content that is selected from the storage unit 710. The extracted digital broadcast signal is decoded by the decoder 740. The AV stream, the data content, and the interactive service control information are multiplexed by the multiplexer 750 by using the aforementioned time information in order to synchronize the AV stream, the data content, and the interactive service control information with one another, and then are finally reproduced on the display unit 760.

As described above, according to the method of storing and reproducing the interactive digital broadcast signals, the history of the user's action during interactive digital broadcast is stored, and the user can determine when and how the user acted while reproducing the recorded broadcast program. Specifically, when the user purchased products through the interactive digital broadcast program, the user can later determine when and how the user purchased the products.

Furthermore, in the case of application data, when the same data is previously stored, since the data does not need to be stored twice, it is possible to prevent wasting of storage space and prevent a system overload caused by storing the same application data.

The method of storing and reproducing the interactive digital broadcast signals according to an embodiment of the present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic-tapes, floppy disks, and optical data storage devices. The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. A method of storing interactive digital broadcast signals, the method comprising:
receiving digital broadcast signals including an audio/video (AV) stream and data content through an external interactive communication channel;
receiving interactive service control information that is input by a user based on the data content; and
storing the AV stream, the data content, and the interactive service control information.

2. The method of claim 1, wherein the storing of the AV stream, the data content, and the interactive service control information comprises storing time information in order to synchronize the AV stream, the data content, and the interactive service control information with one another.

3. The method of claim 2, wherein the interactive service control information is stored in a metadata format.

4. The method of claim 3, wherein the metadata is in accordance with an extensible markup language (XML) standard.

5. The method of claim 2, further comprising separating the received AV stream and the data content as separate files after the receiving of the AV stream and data content.

6. The method of claim 5, wherein the storing of the AV stream and the data content, and the interactive service control information comprises storing the interactive service control information that is input by the user in a same file as the separate AV stream and the data content or as a file separate from the AV stream and the data content.

7. The method of claim 6, wherein the stored interactive service control information represents an input history of the user corresponding to the time information in a time order.

8. A method of reproducing interactive digital broadcast signals, the method comprising:
selecting a content list of digital broadcast signals;
reading the digital broadcast signals of the selected content list;
parsing the read digital broadcast signal into an audio/video (AV) stream, data content, and interactive service control information which represents input information of a user with respect to the data content; and
reproducing the AV stream, the data content, and the interactive service control information which are parsed.

9. The method of claim 8, further comprising multiplexing the AV stream, the data content, and the interactive service control information by using time information in order to synchronize the AV stream, the data content, and the interactive service control information, after the parsing of the read digital broadcast signal.

10. The method of claim 9, wherein the interactive service control information has a metadata format and represents an input history of the user corresponding to the time information.

11. The method of claim 10, wherein the metadata is in accordance with an extensible markup language (XML) standard.

12. The method of claim 10, wherein the input history of the user with respect to the reproduced data content is represented by a text or graphical type.

13. A method of concurrently storing and reproducing interactive digital broadcast signals, the method comprising:
receiving digital broadcast signals including an audio/video (AV) stream and data content through an external interactive communication channel;
receiving interactive service control information that is input by a user the data content;
storing the AV stream, the data content, and the interactive service control information;
parsing the AV stream, the data content, and the interactive service control information which are stored; and
reproducing the AV stream, the data content, and the interactive service control information which are parsed.

14. An apparatus for storing interactive digital broadcast signals, the apparatus comprising:
a tuner which receives digital broadcast signals including an audio/video (AV) stream and data content through an external interactive communication channel;
a classifier which separates the AV stream and the data content as separate files;
a user input unit through which a user inputs interactive service control information based the data content; and
a storage unit which stores the AV stream, the data content, and the interactive service control information which are separated.

15. An apparatus for reproducing interactive digital broadcast signals, the apparatus comprising:
a storage unit which stores digital broadcast signals including an audio/video (AV) stream, data content, and interactive service control information;
a selector which selects a content list of stored digital broadcast signals;
an extractor which extracts the AV stream, the data content, and the interactive service control information by searching for the digital broadcast signals of the selected content list;
a decoder which decodes the AV stream, the data content and the interactive service control information which are extracted by the extractor;
a multiplexer which multiplexes the AV stream, the data content, and the interactive service control information which are the decoded by the decoder by using time information in order to synchronize the AV stream, the data content, and the interactive service control information with one another; and
a display unit which outputs the AV stream, the data content, and the interactive service control information which are multiplexed by the multiplexer onto a screen.

16. A computer-readable recording medium having embodied thereon a computer program for executing a method of storing interactive digital broadcast signals, the method comprising:
receiving digital broadcast signals including an audio/video (AV) stream and data content through an external interactive communication channel;
receiving interactive service control information that is input by a user based on the data content; and
storing the AV stream, the data content, and the interactive service control information.
